(19) United States
(12) Patent Application Publication
(10) Pub. No.: US 2006/0204323 A1
(43) Pub. Date: Sep. 14, 2006

(54) Torque changeable pivot

(76) Inventors: Wen-Ji Tsai, Hsinchuang City (TW); Jung-Wen Chang, Lu Chu Hsiang (TW)

Correspondence Address: RABIN & BERDO, P.C., Suite 500, 1101 14 Street, N.W., Washington, DC, 20005, US

(21) Appl. No.: 11/167,111

(22) Filed: Jun. 28, 2005

(30) Foreign Application Priority Data
Mar. 10, 2005 (TW) 94107335

(51) Int. Cl. F16C 11/00

(52) U.S. Cl. 403/120

(57) ABSTRACT

A torque changeable pivot is described. The torque changeable pivot includes a cylinder, a spindle, and a pin. The cylinder further includes a cylinder shell and the spindle further includes a first rotational portion and a second rotational portion. A peripheral surface of the first rotational portion couples to an inner surface of the cylinder shell and the first rotational portion further includes a first coupling member eccentrically disposed on the first rotational portion. A peripheral surface of the second rotational portion couples to the inner surface of the cylinder shell and the second rotational portion further includes a second coupling member eccentrically disposed on the second rotational portion. When the first coupling member is aligned with the second coupling member and the pin is inserted into the first coupling member and the second coupling member, the first rotational portion and the second rotational portion are combined together.

### RELATED APPLICATIONS

The present application is based on, and claims priority from, Taiwan Application Serial Number 94107335, filed Mar. 10, 2005, the disclosure of which is hereby incorporated by reference herein in its entirety.

### BACKGROUND OF THE INVENTION

1. Field of Invention

The invention relates to a pivot and, in particular, to a torque changeable pivot used in computer manufacturing processes.

2. Related Art

The pivot used in a normal laptop computer or thin display has to provide an appropriate torque to support the weight of the screen. Insufficient torque will result in a loose support for the display screen. If the torque is too large, it will be difficult to adjust the angle of the screen. Take the laptop computers as an example, manufacturers may provide display devices of different sizes and weights in a certain series of laptop computers for selection. During the computer manufacturing process, manufacturers usually have to provide different pivots that are similar in appearance and size but different in torques for display devices of different weights. However, the conventional pivots always provide unchangeable torques and cannot meet these requirements. Moreover, they are similar in appearance and size. It is thus a trouble for material management. Sometimes, wrong pivots will be used and result in a low yield. This inevitably increases the production cost.

### SUMMARY OF THE INVENTION

Therefore, the invention provides a torque changeable pivot that, during a manufacturing process, provides different torques by simply inserting a pin or not.

Another object of the invention is to provide a torque changeable pivot that helps simplify the management of materials using standardized elements.

A further object of the invention is to provide a torque changeable pivot whose torque value is switched according to whether a pin is inserted during the production. It is less likely to put a wrong pivot due to mixed materials.

According to the above-mentioned objects, the disclosed torque changeable pivot includes a cylinder, a spindle, and a pin. The cylinder further includes a cylinder shell and the spindle further includes a first rotational portion and a second rotational portion. A peripheral surface of the first rotational portion couples to an inner surface of the cylinder shell and the first rotational portion further includes a first coupling member eccentrically disposed on the first rotational portion. A peripheral surface of the second rotational portion couples to the inner surface of the cylinder shell and the second rotational portion further includes a second coupling member eccentrically disposed on the second rotational portion. When the first coupling member is aligned with the second coupling member and the pin is inserted into the first coupling member and the second coupling member, the first rotational portion and the second rotational portion are combined together. Therefore, the torque of the torque changeable pivot is increased.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a three-dimensional exploded view of a first embodiment of the invention;

FIG. 2 is a schematic view of the longitudinal cross section of FIG. 1;

FIG. 3 is a schematic view of the longitudinal cross section of the assembled elements in FIG. 1;

FIG. 4A is a schematic view of the longitudinal cross section according to a second embodiment of the invention;

FIG. 4B is a three-dimensional exploded view of FIG. 4A;

FIG. 5 is a schematic view of the longitudinal cross section according to a third embodiment of the invention;

FIG. 6A is a schematic view of the longitudinal cross section according to a fourth embodiment of the invention;

FIG. 6B is a three-dimensional exploded view of FIG. 4A;

FIG. 7 is a schematic view of the longitudinal cross section according to a fifth embodiment of the invention;

FIG. 8 is a schematic view of the longitudinal cross section according to a sixth embodiment of the invention;

FIG. 9 is a schematic view of the longitudinal cross section according to a seventh embodiment of the invention; and

FIG. 10 is a schematic view of the longitudinal cross section according to an eighth embodiment of the invention.

### DETAILED DESCRIPTION OF THE PREFERRED EMBODIMENT

The present invention will be apparent from the following detailed description, which proceeds with reference to the accompanying drawings, wherein the same references relate to the same elements.

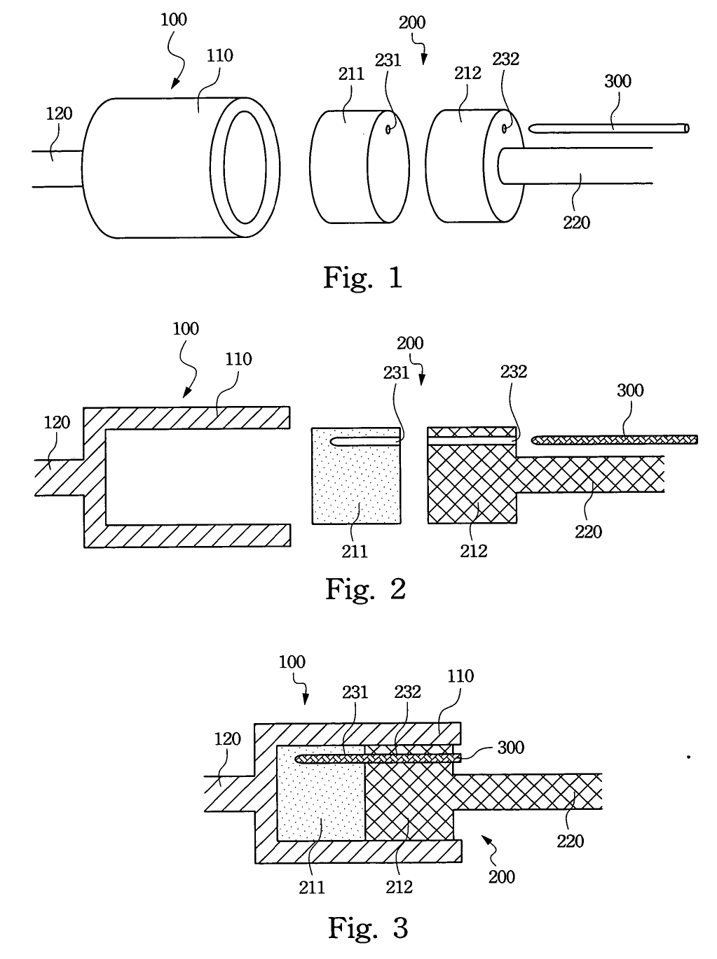

As shown in FIGS. 1, 2, and 3, the disclosed torque changeable pivot includes a cylinder 100, a spindle 200, and a pin 300. The cylinder 100 and the spindle 200 are coupled together using the same axis of the pivot.

The cylinder 100 includes a cylinder shell 110 and a rotational axis 120. The cylinder shell 110 is an axially symmetric cylinder. The bottom of the cylinder shell is perpendicular to the axis of the pivot in a preferred embodiment of the invention. The rotational axis 120 is coupled to the bottom of the cylindrical structure of the cylinder shell 110, extending outward from the pivot. As the rotational axis 120 rotates, the cylinder shell 110 rotates along the rotational axis 120. For different pivots, the invention can eccentrically couple the rotational axis 120 to the cylinder shell 110. The rotational axis 120 is used to couple to the device that is to be installed with a pivot. Alternatively, the invention can be coupled to the device directly with the cylinder shell 110 (not shown).

The spindle 200 includes a first rotational portion 211, a second rotational portion 212, and a rotational axis 220. The first rotational portion 211 has an axially symmetric short axis structure. A peripheral surface of the first rotational portion 211 couples to an inner surface of the cylinder shell 110 when the first rotational portion 211 is disposed in the cylinder shell 110. The first rotational portion 211 further includes a first coupling member 231 eccentrically disposed on a surface of the first rotational portion 211 corresponding to the second rotational portion 212. The first rotational portion 211 includes an opening passing through the first rotational portion 211.

In the preferred embodiment, when the first rotational portion 211 is disposed in the cylinder shell 110, the contact surfaces between the first rotational portion 211 and the bottom of the cylindrical structure of the cylinder shell 110 are planes perpendicular to the axis of the pivot. Accordingly, when the first rotational portion 211 rotates inside the cylinder shell 110, the bottom surface of the cylindrical structure does not interfere with the contact surface of the first rotational portion 211.

The second rotational portion 212 is an axially symmetric short axis. A peripheral surface of the second rotational portion 212 couples to an inner surface of the cylinder shell 110 when the second rotational portion 212 is disposed in the cylinder shell 110. The second rotational portion 212 further includes a second coupling member 232 eccentrically disposed on a surface of the second rotational portion 212. The second coupling member 232 of the second rotational portion 212 is aligned with the first coupling member 231 of the first rotational portion 211. The second rotational portion 212 includes an opening passing through the second rotational portion 212.

The rotational axis 220 is coupled to the second rotational portion 212 with the same axis and extends outward from the pivot. When the rotational axis 220 rotates, the second rotational portion 212 rotates along the rotational axis 220. For different pivots, the invention can also provide eccentric coupling between the rotational axis 220 and the second rotational portion 212. The rotational axis 220 is used to couple to the device that is designed to be installed with a pivot. Alternatively, the invention can be coupled to the device directly with the second rotational portion 212 (not shown).

When both the first rotational portion 211 and the second rotational portion 212 are coupled to the cylinder shell 110, the rotational axis 220 only brings the second rotational portion 212 into motion because the first rotational portion 211 and the second rotational portion 212 do not interfere. The first coupling member 231 and the second coupling member 232 are aligned. In this case, the pin 300 is inserted into the first coupling member 231 and the second coupling member 232 through the openings formed on the first rotational portion 211 and the second rotational portion 212.

In the preferred embodiment, the contact surfaces between the first rotational portion 211 and the second rotational portion 212 are planes perpendicular to the axis of the pivot. That is, the surfaces of the first rotational portion 211 and the second rotational portion 212 are parallel to each other. When the pin 300 is not inserted, the two contact surfaces do not interfere with each other as the second rotational portion 212 rotates inside the cylinder shell 110.

As shown in FIG. 3, when both the first rotational portion 211 and the second rotational portion 212 are coupled to the cylinder shell 110 and the pin 300 is inserted into the second coupling member 232 of the second rotational portion 212 and the first coupling member 231 of the first rotational portion 211, the first rotational portion 211 and the second rotational portion 212 are coupled by the pin 300. When there is a relative motion between the cylinder 100 and the spindle 200, the first rotational portion 211 and the second rotational portion 212 rotate together about the axis of the pivot. In this case, the torque between the cylinder 100 and the spindle 200 is controlled by the friction between the peripheral surfaces of the first rotational portion 211 and the second rotational portion 212 and the inner surface of the cylinder shell 110. Although the friction between the contact surfaces of the first rotational portion 211 and the inner bottom of the cylinder shell 110 also provides a torque, the contact surfaces are made flat in order to avoid interference when the pivot rotates.

When the pin 300 is not inserted, the first rotational portion 211 and the second rotational portion 212 are not coupled. When there is a relative motion between the cylinder 100 and the spindle 200, only the second rotational portion 212 is brought into motion. Therefore, only the friction between the peripheral surface of the second rotational portion 212 and the inner surface of the cylinder shell 110 provides the torque between the cylinder 100 and the spindle 200. The torque is smaller in this case. On the contrary, when the pin 300 is inserted, the first rotational portion 211 and the second rotational portion 212 are coupled. When there is a relative motion between the cylinder 100 and the spindle 200, both the first rotational portion 211 and the second rotational portion 212 are brought into motion. Therefore, the friction between the peripheral surface of the first rotational portion 211 and the inner surface of the cylinder shell 110, and the friction between the peripheral surface of the second rotational portion 212 and the inner surface of the cylinder shell 110 provide the torque between the cylinder 100 and the spindle 200. The torque is larger in this case. Therefore, the invention can control the magnitude of the pivot torque by whether the pin 300 is inserted into the first and second coupling members 231, 232 or not, i.e. whether the first rotational portion 211 and the second rotational portion 212 are coupled.

Various modifications can be made within the scope of the invention. For example, the opening of the cylinder shell 110 can have a constraining structure (not shown) so that the spindle 200 in the cylinder shell 110 is prevented from falling out.

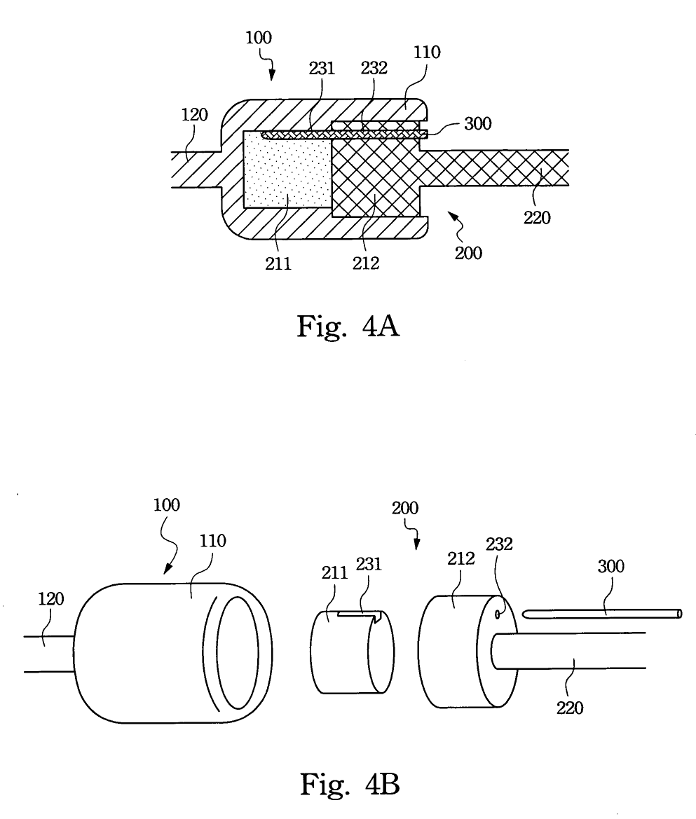

According to the need of adjusting the torque for different devices, as shown in FIGS. 4A and 4B, the first rotational portion 211 and the second rotational portion 212 have different structures in diameter. The first coupling member 231 of the first rotational portion 211 is formed in a groove structure on the peripheral surface of the first rotational portion 211. When the pin 300 is not inserted, the friction between the second rotational portion 212 and the cylinder shell 110 provides the torque between the cylinder 100 and the spindle 200. After the pin 300 is inserted into the first and second coupling members 231, 232, an additional friction between the first rotational portion 211 and the cylinder shell 110 increases the torque between the cylinder 100 and the spindle 200.

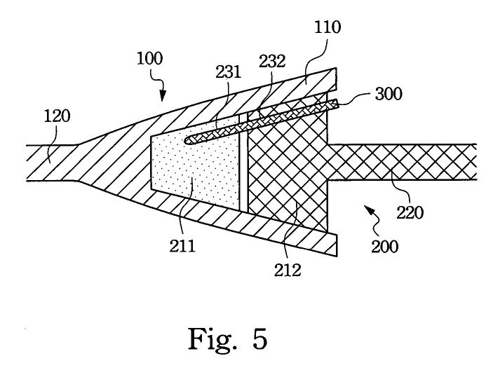

As shown in FIG. 4A, the outer edge of the cylinder shell 110 is smoothed with a curve. Alternatively, as shown in FIG. 5, the cylinder shell 110 is made to have a V-shape cross section along the axis. Correspondingly, the first rotational portion and the second rotational portion have a cross section in the shape of a trapezoid or cone (not shown) along the axis. The first and second coupling members 231, 232 are located in the first rotational portion 211 and the second rotational portion, at an angle with respect to the axis of the pivot. Such configurations can also achieve the effect of changing the torque of the pivot by inserting the pin 300 or not. To avoid interference between the contact surfaces of the first rotational portion 211 and the second rotational portion 212 as the latter rotates inside the cylinder shell 110 and the pin 300 is not inserted, the slant inner surface of the cylinder shell 110 is used to prevent the contact between first rotational portion 211 and the second rotational portion 212.

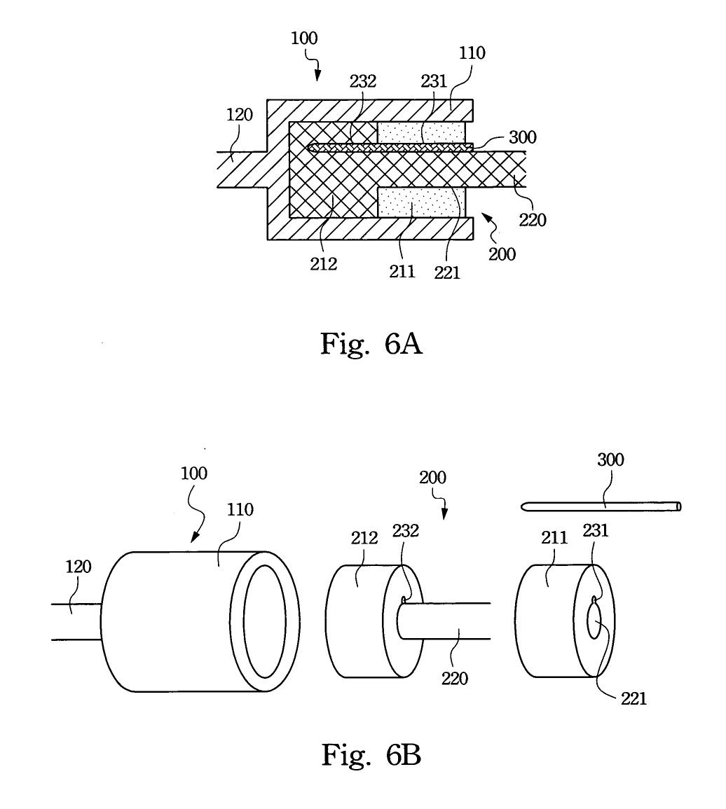

As shown in FIGS. 6A and 6B, the second rotational portion 212 of the rotational axis 220 and the cylinder shell 110 are first coupled, followed by putting the first rotational portion 211 on the outer side of the second rotational portion 212, thereby coupling to the cylinder shell 110. In this case, a through hole 221 is formed in the axis of the first rotational portion 211 to accommodate the rotational axis 220 of the second rotational portion 212. The first coupling member 231 is disposed in a groove structure on one side of the through hole 221. The pin 300 is inserted to the first and second coupling members 231, 232. Such a configuration can also achieve the effect of changing the torque of the pivot by inserting the pin 300 or not.

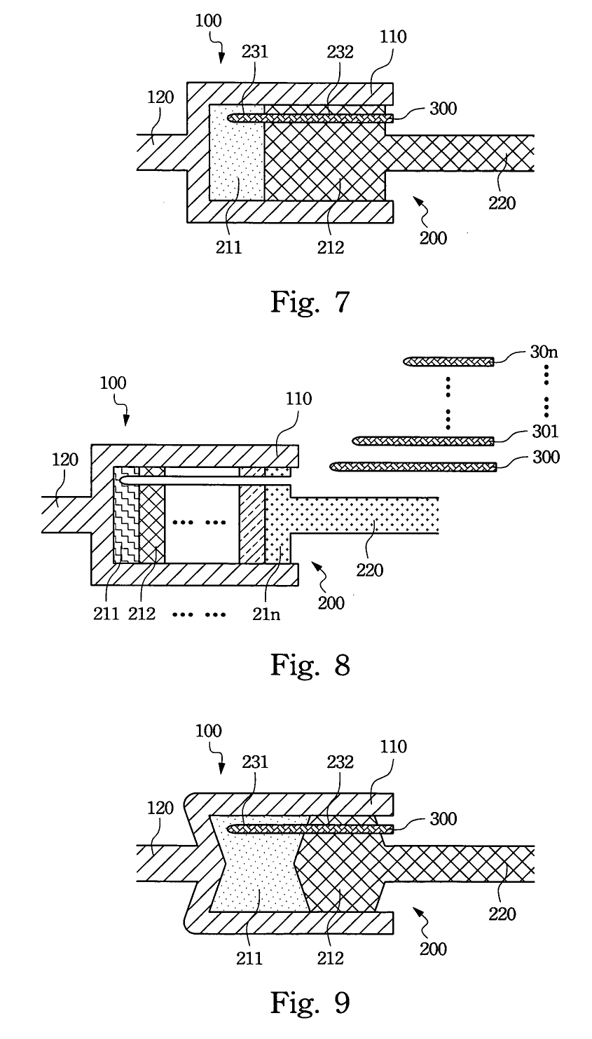

For obtaining different torques, the first and second rotational portions 211, 212 can be made of the same material or different ones. The frictional coefficients (smoothness) of the peripheral surfaces of the first and second rotational portions 211, 212 can be the same or different. Likewise, the frictional coefficient (smoothness) of the inner surface of the cylinder shell 110 and the contact surfaces of the first and second rotational portions 211, 212 can be the same or different. Moreover, we use the first and second rotational portions 211, 212 of the same length in the axes in the above embodiments. However, as shown in FIG. 7, the first and second rotational portions 211, 212 have different axis lengths.

In the above embodiments, the coupling portion of the spindle 200 and the cylinder shell 110 are divided into two portions, the first rotational portion and the second rotational portion. To obtain more possible torques, one may also divide the coupling portion of the spindle 200 and the cylinder shell 110 into several same or different first rotational portion 211, second rotational portion 212, . . . , and nth rotational portion 21n and use pins 300, 301, . . . , 30n of different lengths to adjust the coupling between the spindle 200 and the cylinder shell 110. Therefore, several possible frictional forces can be produced to change the torques, as shown in FIG. 8.

In the above embodiments, the coupling surfaces of the bottom of the cylinder shell 110, the first rotational portion 211, and the second rotational portion 212 are perpendicular to the axis of the pivot. However, these surfaces may have axially symmetric shapes that do not interfere with one another during rotation. For example, they can be the convex and concave cones shown in FIG. 9 or other shapes.

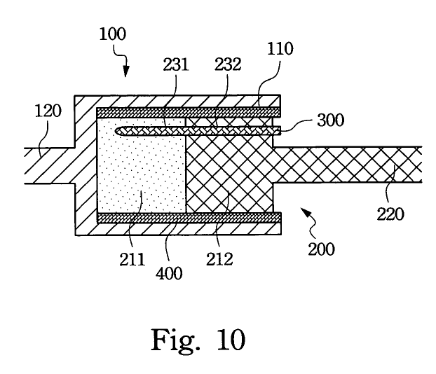

As illustrated in FIG. 10, the disclosed pivot can further includes a pad 400 disposed between the cylinder and the spindle to avoid frictional erosion in between. Such variations should be included in the scope of the appended claims.

It is therefore see that the invention has the following advantages:
1. The appearance of the pivot is the same. Different torques are obtained by inserting a pin or not.
2. The material management is simplified using standardized elements.
3. The torque adjustment is determined by the insertion of the pin during production. Therefore, it is less likely to have a wrong pivot due to mixed materials.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A torque changeable pivot, comprising:
a cylinder, including a cylinder shell;
a spindle, coupled to the cylinder by a same axis, the friction between the cylinder and the spindle providing a torque, and the spindle further including:
a first rotational portion, including a peripheral surface coupled to an inner surface of the cylinder shell, and containing a first coupling member eccentrically disposed on the first rotational portion; and
a second rotational portion, including a peripheral surface coupled to an inner surface of the cylinder shell, and containing a second coupling member eccentrically disposed on the first rotational portion, the second coupling member being aligned with the first coupling member; and
a pin, inserted into the first and second coupling members when they are aligned to couple the first rotational portion and the second rotational portion, thereby changing the torque between the cylinder and the spindle.

2. The torque changeable pivot of claim 1, wherein the first rotational portion and the second rotational portion are made of the same material.

3. The torque changeable pivot of claim 1, wherein the first rotational portion and the second rotational portion are made of different materials.

4. The torque changeable pivot of claim 1, wherein the first rotational portion and the second rotational portion have the same surface frictional coefficient.

5. The torque changeable pivot of claim 1, wherein the first rotational portion and the second rotational portion have different surface frictional coefficients.

6. The torque changeable pivot of claim 1, wherein the first rotational portion and the second rotational portion have the same diameter.

7. The torque changeable pivot of claim 1, wherein the first rotational portion and the second rotational portion have different diameters.

8. The torque changeable pivot of claim 1, wherein the first rotational portion and the second rotational portion have the same axis length.

9. The torque changeable pivot of claim 1, wherein the first rotational portion and the second rotational portion have different axis lengths.

10. The torque changeable pivot of claim 1, wherein the cylinder contains a rotational axis coupled to the cylinder shell to rotate along with the cylinder shell and to couple to the device to be installed with the pivot.

11. The torque changeable pivot of claim 1, wherein the spindle contains a rotational axis coupled to the second rotational portion to rotate along with the second rotational portion and to couple to the device to be installed with the pivot.

12. The torque changeable pivot of claim 1, wherein the opening of the cylinder shell has a constraining structure to avoid the spindle from departing.

13. The torque changeable pivot of claim 1 further comprising a pad disposed between the cylinder and the spindle to avoid direct frictional erosion in between.

14. A torque changeable pivot, comprising:
a cylinder, including a cylinder shell;
a spindle, coupled to the cylinder by a same axis, the friction between the cylinder and the spindle providing a torque, and the spindle further including:
a plurality of rotational portions, coupled to an inner surface of the cylinder shell by their peripheral surfaces and containing a plurality of coupling members eccentrically disposed on the rotational portions, respectively; and
a pin, inserted into the coupling members when they are aligned to couple the rotational portions, thereby changing the torque between the cylinder and the spindle.

15. The torque changeable pivot of claim 14, wherein the rotational portions are made of the same material.

16. The torque changeable pivot of claim 14, wherein the rotational portions are made of different materials.

17. The torque changeable pivot of claim 14, wherein the rotational portions have the same surface frictional coefficient.

18. The torque changeable pivot of claim 14, wherein the rotational portions have different surface frictional coefficients.

19. The torque changeable pivot of claim 14, wherein the rotational portions have the same diameter.

20. The torque changeable pivot of claim 14, wherein the rotational portions have different diameters.

21. The torque changeable pivot of claim 14, wherein the rotational portions have the same axis length.

22. The torque changeable pivot of claim 14, wherein the rotational portions have different axis lengths.

23. The torque changeable pivot of claim 14, wherein the cylinder contains a rotational axis coupled to one of the rotational portions to rotate along with the coupled rotational portion and to couple to the device to be installed with the pivot.

24. The torque changeable pivot of claim 14, wherein the opening of the cylinder shell has a constraining structure to avoid the spindle from departing.

25. The torque changeable pivot of claim 14 further comprising a pad disposed between the cylinder and the spindle to avoid direct frictional erosion in between.
